(19) United States
(12) Patent Application Publication
(10) Pub. No.: US 2025/0015470 A1
(43) Pub. Date: Jan. 9, 2025

(54) Bipolar Storage Battery

(71) Applicants: The Furukawa Battery Co., Ltd., Yokohama (JP); Furukawa Electric Co., Ltd., Tokyo (JP)

(72) Inventors: Kenji Hirota, Iwaki (JP); Yoshinobu Taira, Iwaki (JP)

(21) Appl. No.: 18/893,177

(22) Filed: Sep. 23, 2024

Related U.S. Application Data
(63) Continuation of application No. PCT/JP2023/007097, filed on Feb. 27, 2023.

(30) Foreign Application Priority Data
Mar. 24, 2022 (JP) 2022-048864

(51) Int. Cl. H01M 50/627; H01M 10/12; H01M 50/147

(52) U.S. Cl. CPC H01M 50/627; H01M 10/12; H01M 50/147

(57) ABSTRACT

The occurrence of a short circuit inside a cell member is prevented and the takt time is shortened by forming a through hole to prevent an influence on components, such as deformation of a separator, inside a space housing the cell member caused by an injected electrolyte solution, while also considering case of the injection. A battery includes a plurality of cell members stacked with spacing. Each of the cell members includes a positive electrode, a negative electrode, and a separator interposed between the positive electrode and the negative electrode. The battery includes a space forming member including a substrate and a frame, a plurality of through holes open inside a space housing the cell member, and a lid covering a portion of the frame, the portion surrounding one side face of the cell member. The lid has a communication hole communicating with the plurality of through holes.

### CROSS-REFERENCE TO RELATED APPLICATION(S)

This application is a continuation of PCT Application No. PCT/JP2023/007097, filed Feb. 27, 2023, the disclosure of which is incorporated herein in its entirety by reference.

### TECHNICAL FIELD

Embodiments of the present invention relate to a bipolar storage battery.

### BACKGROUND

These days, the number of power generation facilities utilizing natural energy such as sunlight and wind power is increasing. In such power generation facilities, because the amount of power generation is difficult to control, the power load is leveled by using a storage battery. That is, when the amount of power generation is larger than a consumption, a difference is charged into the storage battery, and when the amount of power generation is smaller than a consumption, a difference is discharged from the storage battery. As the storage battery described above, a lead-acid storage battery is frequently used for economic efficiency, safety, etc. As such a conventional lead-acid storage battery, for example, one described in JP H06-349519 A is known.

The lead-acid storage battery described in JP H06-349519 A includes bipolar plates in each of which a positive active material layer and a negative active material layer are provided on one face and the other face of a conductive metal base material. The bipolar plates are sandwiched between a pair of end plates, and a separator is provided between each pair of adjacent bipolar plates. The lead-acid storage battery used for power storage systems like those described above should be capable of withstanding long-term operation in view of its uses.

### SUMMARY

Here, the separator sandwiched between the positive active material layer and the negative active material layer facing each other is intended to contact the positive active material layer and the negative active material layer to bring an electrolyte solution impregnated in the separator into contact with the positive active material layer and the negative active material layer. Furthermore, the separator is also intended to be pressing the positive active material layer and the negative active material layer.

Accordingly, the separator needs to be in uniform contact with the positive active material layer and the negative active material layer. However, for example, when the electrolyte solution is injected at the time of assembly, the separator may be deformed by the pressure at the time of injecting the electrolyte solution. Uniform contact may be inhibited if the injection amount per unit time is increased to shorten the takt time of the assembly. When the separator is deformed as described above, it may cause not only the positive active material layer and the negative active material layer to not be brought into uniform contact with each other, but also a short circuit is likely to occur between a positive electrode side and a negative electrode side.

Furthermore, if a momentum of injection at the time of injecting the electrolyte solution is strong, it is not always necessary that the injected electrolyte solution has no influence when contacting components of the storage battery other than the separator. It is considered that such a state leads to unexpected shortening of the life of the storage battery.

In this manner, it is necessary to weaken the momentum as described above at the time of injecting the electrolyte solution, but a state where the electrolyte solution does not enter a space housing the cell member is also not preferable in relation to the takt time.

An object of the present invention is to provide a bipolar storage battery that can prevent the occurrence of a short circuit between a positive electrode side and a negative electrode side inside a cell member and shorten the takt time by means of a through hole formed and arranged to prevent an influence on components inside a space housing the cell member caused by the pressure of an electrolyte solution to be injected, such as deformation of a separator, when the electrolyte solution is injected into the space, while also considering ease of the injection.

A bipolar storage battery according to an aspect of the present invention includes a plurality of cell members stacked with spacing. Each of the cell members includes a positive electrode including a positive electrode current collector and a positive active material layer, a negative electrode including a negative electrode current collector and a negative active material layer, and a separator interposed between the positive electrode and the negative electrode. The bipolar storage battery further includes a space forming member forming a plurality of spaces individually housing the plurality of cell members. The space forming member includes a substrate covering at least one of the positive electrode side or the negative electrode side of each of the cell members, and a frame surrounding a side face of each of the cell members. The bipolar storage battery further includes a plurality of through holes open inside (i.e., communicating with) at least one space of the plurality of spaces individually housing the plurality of cell members, and a lid covering a portion of the frame, the portion surrounding one side face of the cell member. The lid has a communication hole communicating with the plurality of through holes.

When such a configuration is adopted, it is possible to prevent the occurrence of the short circuit between the positive electrode side and the negative electrode side inside the cell member. It is also possible to shorten the takt time by means of the through hole formed and arranged to prevent the influence on components inside the space housing the cell member caused by the pressure of the electrolyte solution, such as deformation of the separator, when the electrolyte solution is injected into the space, while also considering ease of the injection.

### BRIEF DESCRIPTION OF THE DRAWINGS

FIG. 1 is a cross-sectional view illustrating a structure of a bipolar lead-acid storage battery according to an embodiment of the present invention.

FIG. 2 is an explanatory view illustrating the positional relationship between the bipolar lead-acid storage battery and a lid according to the embodiment of the present invention.

FIG. 3 is an explanatory view illustrating the positional relationship between the bipolar lead-acid storage battery and the lid according to the embodiment of the present invention.

FIG. 4 is an explanatory view illustrating a state where the lid is attached to the bipolar lead-acid storage battery according to the embodiment of the present invention.

FIG. 5 is a cross-sectional view of the bipolar lead-acid storage battery according to the embodiment of the present invention taken along line A-A illustrated in FIG. 4.

### DETAILED DESCRIPTION

Hereinafter, an embodiment of the present invention will be described in detail with reference to the drawings. Note that the embodiments described below illustrate examples of the present invention. Furthermore, various changes or improvements can be added to each of these embodiments, and a mode to which such changes or improvements are added can also be included in the present invention. These embodiments and modifications thereof are included in the scope of the invention described in the claims and their equivalents. Note that, hereinafter, a lead-acid storage battery will be described as an example from among various storage batteries.

### Overall Configuration

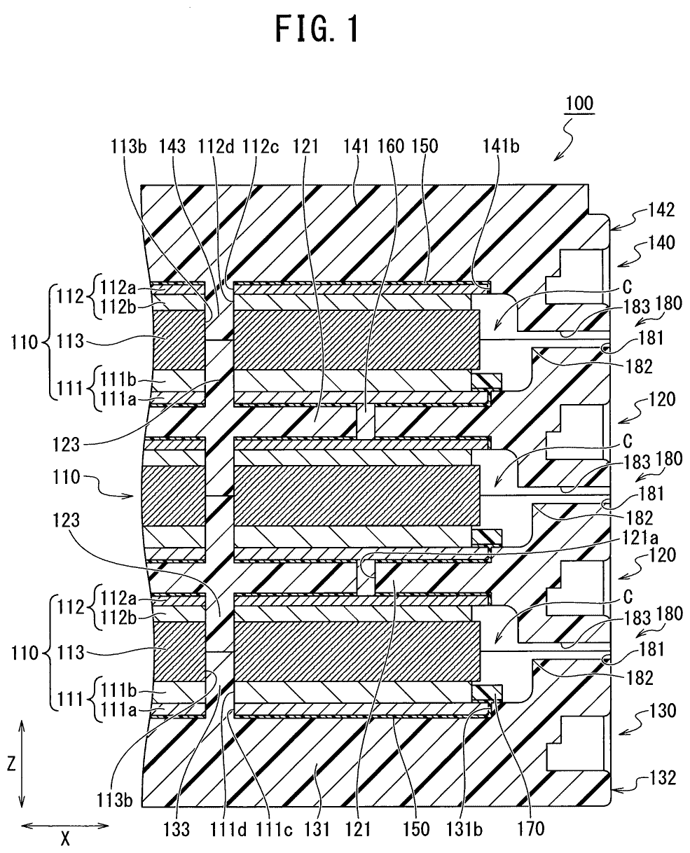

First, an overall configuration of a bipolar lead-acid storage battery in an embodiment of the present invention is described. FIG. 1 is a cross-sectional view illustrating a structure of a bipolar lead-acid storage battery 100 according to a first embodiment of the present invention. Note that illustration of a lid 190 to be described later is omitted in FIG. 1.

As illustrated in FIG. 1, the bipolar lead-acid storage battery 100 of the first embodiment of the present invention includes a plurality of cell members 110, a plurality of bipolar plates 120 (space forming members), a first end plate 130 (space forming member), and a second end plate 140 (space forming member).

Here, although FIG. 1 illustrates a bipolar lead-acid storage battery 100 in which three cell members 110 are stacked, the number of cell members 110 is determined by battery design. The number of bipolar plates 120 is determined according to the number of cell members 110.

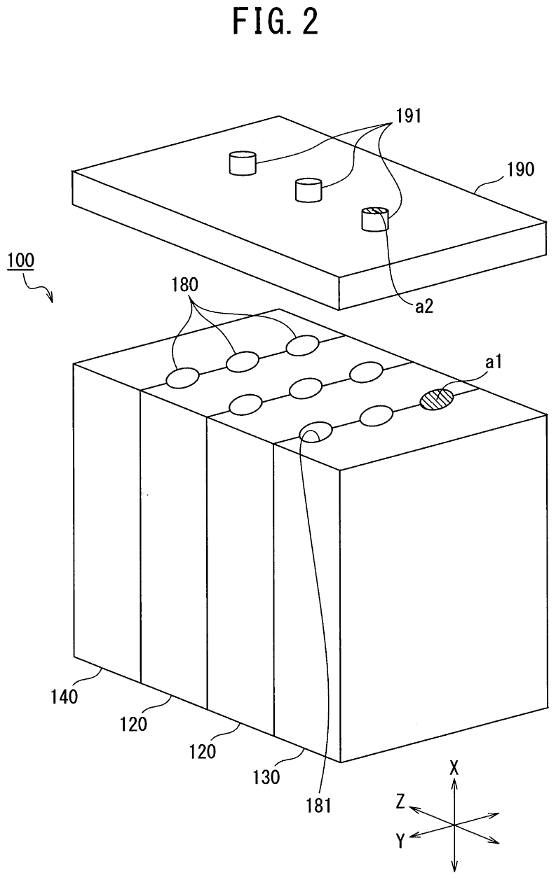

Note that, in the following, as illustrated in FIG. 1 and FIG. 2 and the like to be described later, the stacking direction of the cell members 110 is defined as a Z direction (the up-down direction in FIG. 1), and directions perpendicular to the Z direction and perpendicular to each other are defined as an X direction and a Y direction.

The cell member 110 includes a positive electrode 111, a negative electrode 112, and an electrolyte layer or separator 113. The positive electrode 111 includes a positive electrode lead foil 111a, which is a positive electrode current collector made of lead or a lead alloy, and a positive active material layer 111b. The negative electrode 112 includes a negative electrode lead foil 112a, which is a negative electrode current collector made of lead or a lead alloy, and a negative active material layer 112b.

The positive electrode lead foil 111a is provided on one face (in FIG. 1, a face facing upward in the paper surface) of the bipolar plate 120 by an adhesive 150, which will be described later, provided between the one face of the bipolar plate 120 and the positive electrode lead foil 111a. Therefore, an adhesive layer (e.g., the adhesive 150), the positive electrode lead foil 111a, and the positive active material layer 111b are stacked in this order on the one face of the bipolar plate 120.

On the other hand, the negative electrode lead foil 112a is provided on the other face (in FIG. 1, a face facing downward in the paper surface) of the bipolar plate 120 by the adhesive 150, which will be described later, provided between the other face of the bipolar plate 120 and the negative electrode lead foil 112a. Therefore, an adhesive layer (e.g., the adhesive 150), the negative electrode lead foil 112a, and the negative active material layer 112b are stacked in this order on the other face of the bipolar plate 120. The positive electrode 111 and the negative electrode 112 are electrically connected via a conductor 160 to be described later.

The separator 113 includes, for example, a glass fiber mat impregnated with an electrolyte solution containing sulfuric acid. The separator 113 is provided to be sandwiched between the positive active material layer 111b provided on one of the bipolar plates 120 facing each other and the negative active material layer 112b provided on the other bipolar plate 120. In the cell member 110, the positive electrode lead foil 111a, the positive active material layer 111b, the separator 113, the negative active material layer 112b, and the negative electrode lead foil 112a are stacked in this order.

In the bipolar lead-acid storage battery 100 in the embodiment having such a configuration, as described above, the bipolar plates 120, the positive electrode lead foil 111a, the positive active material layer 111b, the negative electrode lead foil 112a, and the negative active material layer 112b collectively constitute a bipolar electrode. The bipolar electrode refers to an electrode having functions of both the positive electrode and the negative electrode in one electrode.

In the bipolar lead-acid storage battery 100 in the embodiment, the plurality of cell members 110, each of which is formed by interposing the separator 113 between the positive electrode 111 and the negative electrode 112, and the plurality of bipolar plates 120, provided in pairs so as to sandwich each of the cell members 110, are stacked. The outermost layer is assembled by the first end plate 130 and the second end plate 140 to have a battery configuration in which the cell members 110 are connected in series.

Dimensions in the X direction and the Y direction of the positive electrode lead foil 111a are larger than dimensions in the X direction and the Y direction of the positive active material layer 111b. Similarly, dimensions in the X direction and the Y direction of the negative electrode lead foil 112a are larger than dimensions in the X direction and the Y direction of the negative active material layer 112b. Furthermore, for a dimension in the Z direction (thickness), the positive electrode lead foil 111a is larger (thicker) than the negative electrode lead foil 112a, and the positive active material layer 111b is larger (thicker) than the negative active material layer 112b.

The plurality of cell members 110 are arranged with spacing in a stacked manner in the Z direction, and substrates 121 of the bipolar plates 120 are arranged in portions of the spacing. That is, the plurality of cell members 110 are stacked in a state where the substrate 121 of the bipolar plate 120 is sandwiched between the cell members 110.

Thus, the plurality of bipolar plates 120, the first end plate 130, and the second end plate 140 are space forming members for forming a plurality of spaces C (cells) individually housing the plurality of cell members 110.

That is, the bipolar plate 120 is the space forming member including the substrate 121, which covers both the positive electrode 111 side and the negative electrode 112 side of the cell member 110 and has a rectangular planar shape, and a frame 122 surrounding a side face of the cell member 110 and covering the four end faces of the substrate 121.

Furthermore, as illustrated in FIG. 1, the bipolar plate 120 further includes a column 123 perpendicularly protruding from both faces of the substrate 121. The number of columns 123 protruding from each face of the substrate 121 may be one or more.

The substrate 121, the frame 122, and the column 123 that constitute the bipolar plate 120 are integrally formed of, for example, a thermoplastic resin. Examples of the thermoplastic resin forming the bipolar plate 120 include an acrylonitrile-butadiene-styrene copolymer (ABS) resin or polypropylene. These thermoplastic resins are excellent in moldability and in sulfuric acid resistance. Hence, even when the electrolyte solution contacts the bipolar plate 120, decomposition, deterioration, corrosion, and the like hardly occur in the bipolar plate 120.

In the Z direction, a dimension of the frame 122 is larger than a dimension (thickness) of the substrate 121, and a dimension between protruding end faces of the column 123 is the same as the dimension of the frame 122. The plurality of bipolar plates 120 are stacked such that the frames 122 and the columns 123 are in contact with each other, whereby the space C is formed between the substrate 121 and the substrate 121. Then, the dimension in the Z direction of the space C is held by the columns 123 in contact with each other.

Through hole 111c is formed in the positive electrode lead foil 111a. Through hole 111d is formed in the positive active material layer 111b. Through hole 112c is formed in the negative electrode lead foil 112a. Through hole 112d is formed in the negative active material layer 112b. Through hole 113a is formed in the separator 113. Through holes 111c, 111d, 112c, 112d, and 113a allow the column 123 to penetrate.

The substrate 121 of the bipolar plate 120 has a plurality of through holes 121a penetrating the plate surface. A first recess 121b is formed on one face of the substrate 121, and a second recess 121c is formed on the other face. A depth of the first recess 121b is deeper than a depth of the second recess 121c. Dimensions in the X direction and the Y direction of the first recess 121b and the second recess 121c are made to correspond to the dimensions in the X direction and the Y direction of the positive electrode lead foil 111a and the negative electrode lead foil 112a.

The substrate 121 of the bipolar plate 120 is arranged between adjacent cell members 110 in the Z direction. The positive electrode lead foil 111a of the cell member 110 is arranged in the first recess 121b of the substrate 121 of the bipolar plate 120 via the adhesive 150. Furthermore, the negative electrode lead foil 112a of the cell member 110 is arranged in the second recess 121c of the substrate 121 of the bipolar plate 120 via the adhesive 150.

The conductor 160 is arranged in the through hole 121a of the substrate 121 of the bipolar plate 120. Both end faces of the conductor 160 are in contact with and coupled to the positive electrode lead foil 111a and the negative electrode lead foil 112a. That is, the positive electrode lead foil 111a and the negative electrode lead foil 112a are electrically connected by the conductor 160. As a result, all of the plurality of cell members 110 are electrically connected in series.

On an outer edge portion of the positive electrode lead foil 111a, a cover plate 170 for covering the outer edge portion is provided. The cover plate 170 is a thin plate-shaped frame and has a rectangular inner shape line and a rectangular outer shape line. An inner edge portion of the cover plate 170 overlaps with the outer edge portion of the positive electrode lead foil 111a, and an outer edge portion of the cover plate 170 overlaps with a peripheral edge portion of the first recess 121b of one face of the substrate 121.

That is, the rectangle forming the inner shape line of the cover plate 170 is smaller than a rectangle forming an outer shape line of the positive electrode lead foil 111a, and the rectangle forming the outer shape line of the cover plate 170 is larger than a rectangle forming an opening face of the first recess 121b.

The adhesive 150 runs around from an end face of the positive electrode lead foil 111a to an outer edge portion on the opening side of the first recess 121b, and the adhesive 150 is arranged between the inner edge portion of the cover plate 170 and the outer edge portion of the positive electrode lead foil 111a. Furthermore, the adhesive 150 is also arranged between the outer edge portion of the cover plate 170 and one face of the substrate 121.

That is, the cover plate 170 is fixed by the adhesive 150 over the peripheral edge portion of the first recess 121b on one face of the substrate 121 and the outer edge portion of the positive electrode lead foil 111a. Thus, the outer edge portion of the positive electrode lead foil 111a is covered with the cover plate 170 also in a boundary portion with the peripheral edge portion of the first recess 121b.

Note that, although not illustrated in FIG. 1, an outer edge portion of the negative electrode lead foil 112a may also be covered with a cover plate similar to the cover plate 170 covering an outer edge portion of the positive electrode lead foil 111a. Furthermore, the cover plate has been described as an example of a thin plate-shaped frame, but, for example, a tape-shaped object or the like may be used so long as the cover plate has electrolyte solution resistance (e.g., sulfuric acid resistance).

As illustrated in FIG. 1, the first end plate 130 is a space forming member including a substrate 131 covering the positive electrode side of the cell member 110 and a frame 132 surrounding a side face of the cell member 110. Furthermore, a column 133 vertically protruding from one face of the substrate 131 (a face facing the substrate 121 of the bipolar plate 120 arranged most on the positive electrode side) is provided.

The substrate 131 has a rectangular planar shape. Four end faces of the substrate 131 are covered with the frame 132. The substrate 131, the frame 132, and the column 133 are integrally formed of, for example, the above-described thermoplastic resin. Note that the number of columns 133 protruding from each face of the substrate 131 may be one or more. However, the number corresponds to the number of columns 133 of the bipolar plate 120 to be brought into contact with the columns 123.

In the Z direction, a dimension of the frame 132 is larger than a dimension (thickness) of the substrate 131, and a dimension between protruding end faces of the column 133 is the same as the dimension of the frame 132. The first end plate 130 is stacked such that the frame 132 and the column 133 are in contact with the frame 122 and the column 123 of the bipolar plate 120 arranged on the outermost side (e.g., the positive electrode side).

Thus, the space C is formed between the substrate 121 of the bipolar plate 120 and the substrate 131 of the first end plate 130. Furthermore, a dimension in the Z direction of the space C is held by the column 123 of the bipolar plate 120 and the column 133 of the first end plate 130 in contact with each other.

The through holes 111c, 111d, and 113a allowing the column 133 to penetrate are formed in the positive electrode lead foil 111a, the positive active material layer 111b, and the separator 113 of the cell member 110 arranged on the outermost side (e.g., positive electrode side), respectively.

A recess 131b is formed on one face of the substrate 131 of the first end plate 130. Dimensions in the X direction and the Y direction of the recess 131b are made to correspond to the dimensions in the X direction and the Y direction of the positive electrode lead foil 111a.

The positive electrode lead foil 111a of the cell member 110 is arranged in the recess 131b of the substrate 131 of the first end plate 130 via the adhesive 150. Furthermore, the cover plate 170 is fixed to one face side of the substrate 131 by the adhesive 150 like on the substrate 121 of the bipolar plate 120. As a result, the outer edge portion of the positive electrode lead foil 111a is covered with the cover plate 170 also in a boundary portion with a peripheral edge portion of the recess 131b.

Furthermore, the first end plate 130 includes a positive electrode terminal (not illustrated in FIG. 1) electrically connected to the positive electrode lead foil 111a in the recess 131b.

The second end plate 140 is a space forming member including a substrate 141 covering the negative electrode side of the cell member 110 and a frame 142 surrounding a side face of the cell member 110. Furthermore, a column 143 vertically protruding from one face of the substrate 141 (a face facing the substrate 121 of the bipolar plate 120 arranged most on the negative electrode side) is provided.

The substrate 141 has a rectangular planar shape. Four end faces of the substrate 141 are covered with the frame 142. The substrate 141, the frame 142, and the column 143 are integrally formed of, for example, the above-described thermoplastic resin. Note that the number of columns 143 protruding from each face of the substrate 141 may be one or more. However, the number corresponds to the number of columns 123 of the bipolar plate 120 to be brought into contact with the columns 143.

In the Z direction, a dimension of the frame 142 is larger than a dimension (thickness) of the substrate 141, and a dimension between protruding end faces of the two columns 143 is the same as the dimension of the frame 142. The second end plate 140 is stacked such that the frame 142 and the column 143 are in contact with the frame 122 and the column 123 of the bipolar plate 120 arranged on the outermost side (the negative electrode side).

Thus, the space C is formed between the substrate 121 of the bipolar plate 120 and the substrate 141 of the second end plate 140. Furthermore, a dimension in the Z direction of the space C is held by the column 123 of the bipolar plate 120 and the column 143 of the second end plate 140 in contact with each other.

The through holes 112c, 112d, and 113a allowing the column 143 to penetrate are formed in the negative electrode lead foil 112a, the negative active material layer 112b, and the separator 113 of the cell member 110 placed on the outermost side (e.g., the negative electrode side), respectively.

A recess 141b is formed on one face of the substrate 141 of the second end plate 140. Dimensions in the X direction and the Y direction of the recess 141b are made to correspond to the dimensions in the X direction and the Y direction of the negative electrode lead foil 112a.

The negative electrode lead foil 112a of the cell member 110 is arranged in the recess 141b of the substrate 141 of the second end plate 140 via the adhesive 150. Furthermore, the second end plate 140 includes a negative electrode terminal, which is not illustrated in FIG. 1, electrically connected to the negative electrode lead foil 112a in the recess 141b.

When joining the bipolar plates 120 facing each other, for example, the first end plate 130 and the facing bipolar plate 120, or the second end plate 140 and the facing bipolar plate 120, various welding methods such as vibration welding, ultrasonic welding, or hot plate welding can be employed. Vibration welding is performed by vibrating faces to be joined while pressurizing the faces at the time of joining and has a fast cycle of welding and good reproducibility. Therefore, vibration welding is more preferably used.

Note that objects to be welded include not only frames but also the respective columns arranged in facing positions on facing bipolar plates 120, the first end plate 130, and the second end plate 140.

The bipolar lead-acid storage battery 100 includes a plurality of through holes 180 open to the space C housing the cell member 110. A through hole 180 is formed in one of four end faces of the bipolar plate 120, the first end plate 130, and the second end plate 140.

Taking the bipolar plate 120 as an example, the through hole 180 formed on the right side in FIGS. 1 and 2, for example, includes an outer opening 181 open toward the outside of the bipolar plate 120, an inner opening 182 communicating with the space C, and a through path 183 connecting the outer opening 181 and the inner opening 182.

Note that, similarly, the first end plate 130 includes the outer opening 181 open toward the outside thereof and the inner opening 182 communicating with the space C, and the through path 183 is formed to connect the outer opening 181 and the inner opening 182.

Furthermore, the second end plate 140 also includes the outer opening 181 open toward the outside thereof and the inner opening 182 communicating with the space C, and the through path 183 is formed to connect the outer opening 181 and the inner opening 182.

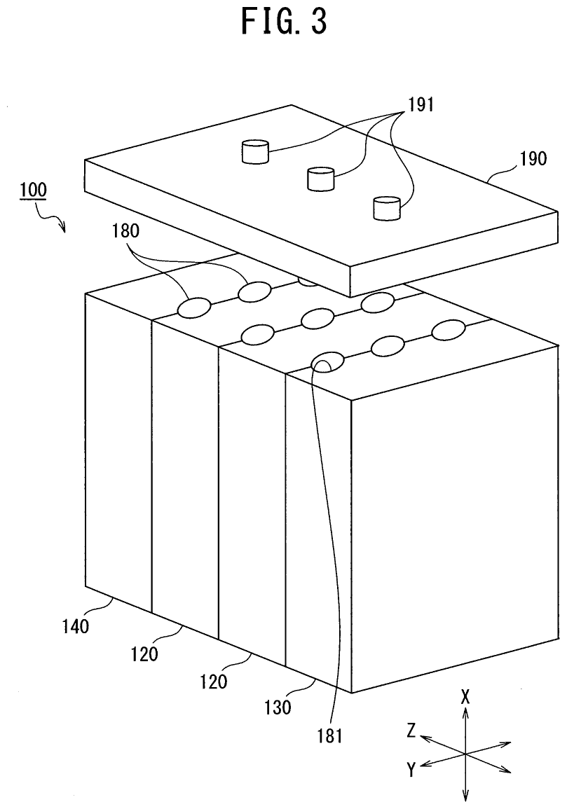

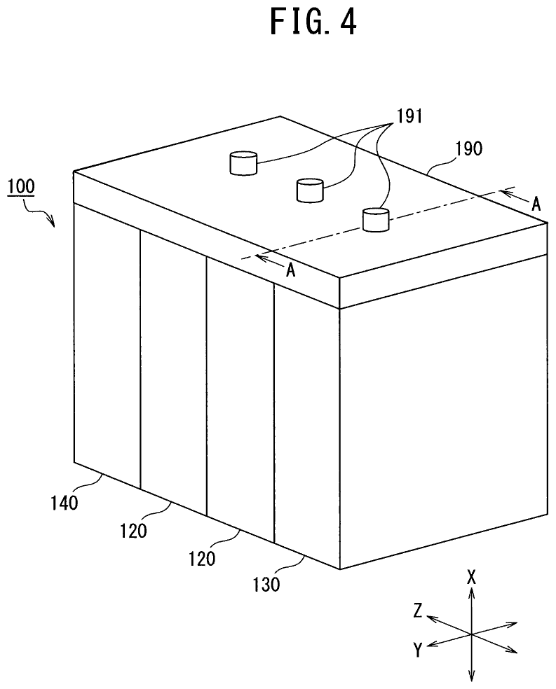

Here, FIGS. 2 and 3 are explanatory views illustrating the positional relationship between the bipolar lead-acid storage battery 100 and a lid 190 according to this embodiment. Furthermore, FIG. 4 is an explanatory view illustrating a state where the lid 190 is attached to the bipolar lead-acid storage battery 100 according to this embodiment.

The bipolar lead-acid storage battery 100 in FIGS. 2 to 4 is rotated by 90 degrees from the orientation illustrated in FIG. 1 and drawn such that a Y-Z plane is oriented in the up-down direction of the drawing. When the bipolar lead-acid storage battery 100 is placed in such an orientation, the Y-Z plane is a ground plane, and the X direction is a direction parallel to the vertical direction.

Furthermore, in the bipolar lead-acid storage battery 100 shown in FIGS. 2 to 4, two bipolar plates 120 are sandwiched between the first end plate 130 and the second end plate 140 as in FIG. 1. The through holes 180 are formed at contact positions among the respective plates.

That is, the through holes 180 are formed, for example, on the right side in FIG. 1 in the space forming members such as the bipolar plate 120, the first end plate 130, and the second end plate 140. Therefore, as illustrated in FIGS. 2 to 4, the through holes 180 appear at positions facing the lid 190, and the outer openings 181 are visible.

The lid 190 is shown in the upper part of the bipolar lead-acid storage battery 100 in the X direction. The lid 190 is arranged to cover a portion surrounding one side face of the cell member 110 of each of the frame 122, frame 132, and frame 142 of the facing bipolar lead-acid storage battery 100 as can be seen in order from FIGS. 2 to 4.

Note that, in FIGS. 2 to 4, only a structure necessary in this embodiment out of structures of the lid 190 is drawn. Therefore, the drawing of the other structures of the lid 190 is omitted.

The lid 190 is provided with at least one communication hole 191 communicating with a plurality of the through holes 180. The communication hole 191 serves as a through hole used for injecting the electrolyte solution into the space C at the time of manufacturing. That is, after the lid 190 is attached to the bipolar lead-acid storage battery 100 (see FIG. 4), the electrolyte solution is injected into the space C from the communication hole 191 through each of the through holes 180.

After a necessary (e.g., adequate) amount of the electrolyte solution is injected, the communication hole 191 is sealed. Therefore, after manufacturing, the communication hole 191 serves as an exhaust port for exhausting gas generated in the space C housing the cell member 110.

As illustrated in FIGS. 2 and 3, three through holes 180 are formed at a boundary between adjacent plates along the boundary. Only one through hole 180 has been provided at a boundary between adjacent plates so far.

However, in a case where only one through hole 180 is provided, adverse effects, for example, that the electrolyte solution is less likely to enter the space C, or that the electrolyte solution injected from the communication hole 191 is injected into the space C with enough momentum to affect the cell member 110, such as the separator 113, are considered when injecting the electrolyte solution into the space C.

Therefore, in the bipolar lead-acid storage battery 100 in this embodiment, the injected electrolyte solution is dispersed from the plurality of through holes 180 and injected into the space C by providing the plurality of through holes 180. Therefore, the momentum when injecting the electrolyte solution can be weakened.

Furthermore, even in a case where it is difficult to inject the electrolyte solution into the space C with only one through hole 180, the electrolyte solution can be injected into the space C from any one of the plurality of provided through holes 180, and thus, the takt time can be shortened.

Furthermore, because the plurality of through holes 180 are provided, even when gas is generated in the space C, the generated gas is easily released to the outside of the bipolar lead-acid storage battery 100 through the through holes 180 and the communication holes 191.

When a specific total opening area of the through holes 180 is desired, an opening area per through hole 180 is smaller in a case where the plurality of through holes 180 are provided compared to where one through hole 180 is provided. Thus, the strength of each of the frame 122, frame 132, and frame 142 constituting the space forming member can be easily ensured.

Note that the three through holes 180 are provided as described above in the bipolar lead-acid storage battery 100 in this embodiment, but the number thereof can be arbitrarily set as long as it is two or more.

Instead of an arrangement position as illustrated in FIG. 2 and the like, for example, the arrangement position can be arbitrarily set by, for example, arranging the plurality of through holes 180 to be gathered at the center in the Y direction or to be close to any end in the Y direction of the frame 122 or the like.

The three through holes 180 are provided at equal intervals (i.e., a distance between each through hole 180) in FIG. 2 and the like, but the intervals thereof are not necessarily equal. Furthermore, sizes of the provided through holes 180 are not necessarily equal.

In the bipolar lead-acid storage battery 100 in the embodiment of the present invention, a shape of the through hole 180 is a long hole (e.g., an ellipse) shape as illustrated in FIGS. 2 and 3. This is because a thickness (length) in the stacking direction (Z direction) of each plate can be reduced (shortened) by forming the frame 122 and the like to have such a shape, which can contribute to the compactness of the entire bipolar lead-acid storage battery 100. However, the shape of the through hole 180 is not limited to such a long hole shape, and for example, a shape such as a perfect circle or a quadrangle can be freely set.

In the bipolar lead-acid storage battery 100 illustrated in FIG. 2 and the like, the through hole 180 is formed at the position that is the boundary between adjacent plates. However, the position where the through hole 180 is formed is not limited to such a position. That is, in a case where the through hole 180 is provided at the boundary between adjacent plates, the through hole 180 is formed at a position serving as a stacked face when the adjacent plates are stacked. Therefore, instead of such a position, for example, the through hole 180 may be formed at a position that does not become the above-described stacked face on the space forming member.

Specifically, for example, the through hole 180 may be provided at a position shifted upward or downward in the Z direction from the position of the through hole 180 illustrated in the cross-sectional view of the bipolar lead-acid storage battery 100 illustrated in FIG. 1. In this case, the inner opening 182 naturally communicates with the space C.

Note that arrangement positions and the like of the outer opening 181 and the inner opening 182 related to the through hole 180 have been described so far. Opening shapes of the outer opening 181 and the inner opening 182 can be, for example, circular or elliptical. Furthermore, diameters of these openings can be set to, for example, 1 mm to 5 mm.

An opening shape of the communication hole 191 can also be, for example, a circular shape or an elliptical shape. Furthermore, a diameter of this opening can be, for example, 4 mm to 10 mm.

In this embodiment, the relationship between the through hole 180 and the communication hole 191 of the lid 190 is set as follows. That is, a cross-sectional area of a cross section of the through hole 180 orthogonal to the injection direction of the electrolyte solution is defined as a first opening area a1.

As illustrated in FIG. 2 and the like, three through holes 180 are formed at boundaries between adjacent plates. Therefore, a total opening area of the first opening areas al of the three through holes 180 is “3×a1”.

On the other hand, a cross-sectional area of a cross section of one communication hole 191 provided in the lid 190 orthogonal to the injection direction of the electrolyte solution is defined as a second opening area a2. Here, a value grasped as a “cross-sectional area” for both the first opening area al and the second opening area a2 is a value at which the cross-sectional area is the smallest in each portion of the through holes 180.

The relationship between the first opening area al and the second opening area a2 is “3×a1>a2”. That is, the total opening area of the first opening areas al in the respective through holes 180 provided at the boundary between the adjacent plates is equal to or larger than the second opening area a2 of the communication hole 191.

More specifically, the total opening area of the first opening areas al is 1.5 times or more and 4 times or less (i.e., between 1.5 and 4 times, inclusive) the second opening area a2. Meanwhile, the first opening area a1, which is the cross-sectional area of each of the through holes 180, is 0.5 times or more and less than 4 times the second opening area a2.

As described above, the plurality of through holes 180 are provided, and the relationship between the through hole 180 formed at the boundary between adjacent plates and the communication hole 191 of the lid 190 is set such that the total opening area of the plurality of through holes 180 is equal to or larger than the total opening area (second opening area) of the communication hole 191, whereby the openings communicating with space C can be made large.

That is, when the electrolyte solution is injected into the space C of the bipolar lead-acid storage battery 100 from the communication hole 191, the electrolyte solution is dispersed in each of the through holes 180, so that the momentum of the electrolyte solution can be weakened. Therefore, it is possible to minimize an influence of the pressure of the electrolyte solution on the cell member 110 during injection. Furthermore, because the electrolyte solution is injected into the space C through any one of the through holes 180, it is possible to avoid an increase in time required for the injection.

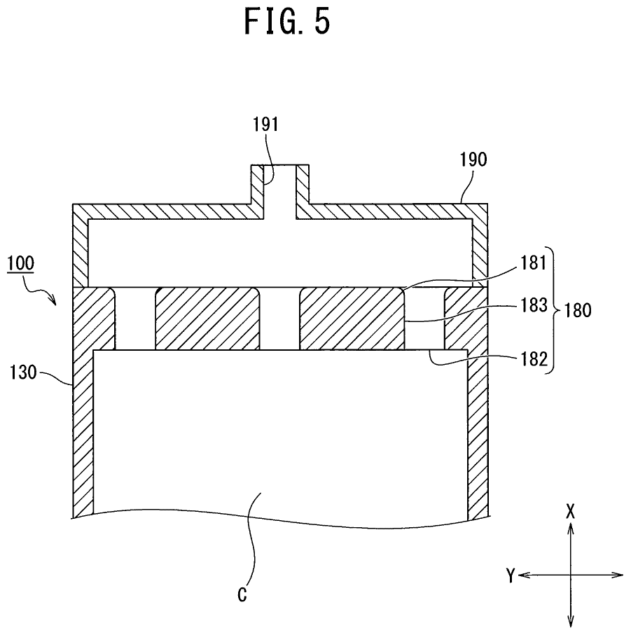

FIG. 5 is a cross-sectional view of the bipolar lead-acid storage battery 100 according to and embodiment of the present invention taken along line A-A illustrated in FIG. 4. Note that illustration of each configuration of the cell member 110 arranged in the space C is omitted in FIG. 5.

As illustrated in FIG. 5, the electrolyte solution injected from the communication hole 191 of the lid 190 is injected into the space C through the plurality of (in this example, three) through holes 180. In this example, the outer opening 181 is formed in a tapered shape in a region continuing from the outer opening 181 to the through path 183.

Because the outer opening 181 is formed in such a tapered shape, the electrolyte solution injected from the communication hole 191 more easily enters the through hole 180, which contributes to smooth injection of the electrolyte solution into the space C.

### Manufacturing Method

The bipolar lead-acid storage battery 100 of this embodiment can be manufactured by, for example, a method including each of steps to be described hereinafter.

### Step of Producing Bipolar Plate Equipped With Positive Electrode Lead Foil and Negative Electrode Lead Foil

First, the substrate 121 of the bipolar plate 120 is placed on a worktable with the first recess 121b side facing upward. Then, the adhesive 150 is applied to the first recess 121b, and the positive electrode lead foil 111a is placed in the first recess 121b. At this time, the column 123 of the bipolar plate 120 is set to pass through the through hole 111c of the positive electrode lead foil 111a. The adhesive 150 is cured to attach the positive electrode lead foil 111a to one face of the substrate 121.

Next, the substrate 121 is placed on the worktable with the second recess 121c side facing upward, and the conductor 160 is inserted into the through hole 121a. Then, the adhesive 150 is applied to the second recess 121c, and the negative electrode lead foil 112a is placed in the second recess 121c. At this time, the column 123 of the bipolar plate 120 is set to pass through the through hole 112c of the negative electrode lead foil 112a. The adhesive 150 is cured to attach the negative electrode lead foil 112a to the other face of the substrate 121.

Next, the substrate 121 is placed on the worktable with the first recess 121b side facing upward. Then, the adhesive 150 is applied onto an outer edge portion of the positive electrode lead foil 111a and an upper face of the substrate 121 to be an edge portion of the first recess 121b, the cover plate 170 is placed thereon, and the adhesive 150 is cured. Thus, the cover plate 170 is fixed over the outer edge portion of the positive electrode lead foil 111a and a portion of the substrate 121 continuous to the outside thereof (a peripheral edge portion of the first recess 121b).

Next, resistance welding is performed to connect the conductor 160, the positive electrode lead foil 111a, and the negative electrode lead foil 112a. Thus, the bipolar plate 120 equipped with positive electrode lead foil and negative electrode lead foil is obtained. A desired number of the bipolar plates 120 equipped with positive electrode lead foil and negative electrode lead foil are prepared.

### Step of Producing end Plate Equipped With Positive Electrode Lead Foil

The substrate 131 of the first end plate 130 is placed on a worktable with the recess 131b side facing upward. Then, the adhesive 150 is applied to the recess 131b, the positive electrode lead foil 111a is placed in the recess 131b, and the adhesive 150 is cured. At this time, the column 133 of the end plate 130 is set to pass through the through hole 111c of the positive electrode lead foil 111a. The adhesive 150 is cured to attach the positive electrode lead foil 111a to one face of the substrate 131.

Next, the adhesive 150 is applied onto an outer edge portion of the positive electrode lead foil 111a and an upper face of the substrate 131 to be an edge portion of the recess 131b. The cover plate 170 is placed on the adhesive 150, and the adhesive 150 is cured. Thus, the cover plate 170 is fixed over the outer edge portion of the positive electrode lead foil 111a and a portion of the substrate 131 continuous to the outside thereof. Thus, an end plate equipped with a positive electrode lead foil is obtained.

### Step of Producing end Plate Equipped With Negative Electrode Lead Foil

The substrate 141 of the second end plate 140 is placed on a worktable with the recess 141b side facing upward. Then, the adhesive 150 is applied to the recess 141b, the negative electrode lead foil 112a is placed in the recess 141b, and the adhesive 150 is cured. At this time, the column 143 of the second end plate 140 is set to pass through the through hole 112c of the negative electrode lead foil 112a. The adhesive 150 is cured to obtain the second end plate 140 equipped with the negative electrode lead foil 112a attached to one face of the substrate 141.

### Step of Stacking and Joining Plates

First, the first end plate 130 to which the positive electrode lead foil 111a and the cover plate 170 are fixed is placed on a worktable with the positive electrode lead foil 111a facing upward. Then, the positive active material layer 111b is placed in the cover plate 170 and is positioned on the positive electrode lead foil 111a. At this time, the column 133 of the first end plate 130 is set to pass through the through hole 111d of the positive active material layer 111b. Next, the separator 113 and the negative active material layer 112b are placed on the positive active material layer 111b.

Next, on the first end plate 130 in this state, the negative electrode lead foil 112a side of the bipolar plate 120 equipped with positive electrode lead foil and negative electrode lead foil is placed to face downward. At this time, the column 123 of the bipolar plate 120 is set to pass through the through hole 113a of the separator 113 and the through hole 112d of the negative active material layer 112b, and the column 123 is positioned on the column 133 of the first end plate 130. Then, the frame 122 of the bipolar plate 120 is put on the frame 132 of the first end plate 130.

In this state, the first end plate 130 is fixed, and vibration welding is performed while the bipolar plate 120 is vibrated in a diagonal direction of the substrate 121. Thus, the frame 122 of the bipolar plate 120 is joined onto the frame 132 of the first end plate 130. Furthermore, the column 123 of the bipolar plate 120 is joined onto the column 133 of the first end plate 130.

As a result, the bipolar plate 120 is joined onto the first end plate 130 to form a coupled body. A state is formed in which the cell member 110 is arranged in the space C formed by the first end plate 130 and the bipolar plate 120, and the positive electrode lead foil 111a is exposed on an upper face of the bipolar plate 120.

Next, the positive active material layer 111b, the separator 113, and the negative active material layer 112b are placed in this order on the coupled body. After that, another bipolar plate 120 equipped with positive electrode lead foil and negative electrode lead foil is placed with the negative electrode lead foil 112a side facing downward.

In this state, the coupled body is fixed, and vibration welding is performed while another bipolar plate 120 equipped with positive electrode lead foil and negative electrode lead foil is vibrated in a diagonal direction of the substrate 121. These stacking and vibration welding steps are continually performed until the required number of bipolar plates 120 are joined onto the first end plate 130.

Finally, the positive active material layer 111b, the separator 113, and the negative active material layer 112b are placed in this order on the uppermost bipolar plate 120 of the coupled body in which all the bipolar plates 120 are joined. After that, the second end plate 140 is further placed with the negative electrode lead foil 112a side facing downward.

In this state, the coupled body is fixed, and vibration welding is performed while the second end plate 140 is vibrated in a diagonal direction of the substrate 141. Thus, the second end plate 140 is joined onto the uppermost bipolar plate 120 of the coupled body in which all the bipolar plates 120 are joined.

Note that the flow of performing stacking sequentially from the first end plate 130 toward the second end plate 140 has been described in the above description. However, this stacking order may be conversely set such that stacking is performed sequentially from the second end plate 140 toward the first end plate 130.

### Step of Injection and Chemical Conversion

In the above step of stacking and joining the plates, a joint structure by vibration welding between facing faces of the frames is formed, and three through holes 180, for example, is formed by cutout portions of the facing frames. Then, the lid 190 is attached to cover the through holes 180 of the bipolar lead-acid storage battery 100.

Then, a predetermined amount of an electrolyte solution is injected into the communication hole 191 provided in the lid 190. The electrolyte solution injected into the communication hole 191 is injected into the space C through the plurality of through holes 180. Thus, the separator 113 can be impregnated with the electrolyte solution. Then, chemical conversion is performed under predetermined conditions, and thereby the bipolar lead-acid storage battery 100 can be produced.

Note that the bipolar lead-acid storage battery 100 has been described as an example of an embodiment of the present invention as described above. However, when the above description applies to other storage batteries in which other metals are used instead of lead for current collectors, the application of the above description is not excluded, as a matter of course.

The following is a list of reference signs used in this specification and in the drawings.
100 Bipolar lead-acid storage battery
110 Cell member
111 Positive electrode
112 Negative electrode
111a Positive electrode lead foil
112a Negative electrode lead foil
111b Positive active material layer
112b Negative active material layer
113 Separator
120 Bipolar plate
121 Substrate of bipolar plate
121a Through hole of substrate
122 Frame of bipolar plate
123 Column
130 First end plate
131 Substrate of first end plate
132 Frame of first end plate
133 Column
140 Second end plate
141 Substrate of second end plate
142 Frame of second end plate
143 Column
150 Adhesive
160 Conductor
170 Cover plate
180 Through hole
181 Outer opening
182 Inner opening
183 Through path
190 Lid
191 Communication hole
a1 First opening area
a2 Second opening area
C Cell (space accommodating cell member)

What is claimed is:

1. A bipolar storage battery, comprising:
a plurality of cell members stacked with spacing, each of the cell members including a positive electrode including a positive electrode current collector and a positive active material layer, a negative electrode including a negative electrode current collector and a negative active material layer, and a separator interposed between the positive electrode and the negative electrode;
a space forming member forming a plurality of spaces individually housing the plurality of cell members, the space forming member including a substrate covering at least one of the positive electrode side or the negative electrode side of each of the cell members, and a frame surrounding a side face of each of the cell members;
a plurality of through holes communicating with at least one space of the plurality of spaces individually housing the plurality of cell members; and
a lid covering a portion of the frame, the portion surrounding one side face of the cell member, wherein the lid has a communication hole communicating with the plurality of through holes.

2. The bipolar storage battery according to claim 1, wherein each of the plurality of through holes has a first opening area, the communication hole has a second opening area, and a total opening area of the first opening areas is equal to or larger than the second opening area.

3. The bipolar storage battery according to claim 2, wherein the total opening area of the first opening areas is between 1.5 and 4 times, inclusive, the second opening area.

4. The bipolar storage battery according to claim 2, wherein the first opening area is 0.5 times or more and less than 4 times the second opening area.

5. The bipolar storage battery according to claim 3, wherein the first opening area is 0.5 times or more and less than 4 times the second opening area.

6. The bipolar storage battery according to claim 1, wherein the positive electrode current collector and the negative electrode current collector are made of lead or a lead alloy.
